(19) United States
(12) Patent Application Publication
(10) Pub. No.: US 2026/0320673 A1
(43) Pub. Date: Oct. 15, 2026

(54) Gift Giving System and Gift Giving Method Therefor

(71) Applicants: Jianlin DAI, Maanshan, Anhui (CN); Anhui Playbar New Retailer Company Co., Ltd., Maanshan City, Anhui Province (CN)

(72) Inventor: Jianlin Dai, Maanshan City, Anhui Province (CN)

(21) Appl. No.: 18/880,842

(22) PCT Filed: Jul. 4, 2023
(86) PCT No.: PCT/CN2023/105736

§ 371 Date: Jan. 2, 2025

(30) Foreign Application Priority Data
Jul. 5, 2022 (CN) 202210787568.7

(51) Int. Cl. G06Q 30/0601

(52) U.S. Cl. CPC G06Q 30/06331; G06Q 30/0621; G06Q 30/0643

(57) ABSTRACT

Disclosed in the present invention is a gift giving system including a user module and a payment module, wherein the user module manages a set of user accounts, and the user management module receives a gift list and stores the gift list in a user account of a gift recipient, and the payment module converts an item recorded in the gift list into a value unit of an equal amount and stores same in the user account corresponding to the gift recipient.

### BACKGROUND OF THE PRESENT INVENTION

### Field of Invention

The present invention relates to a computer system, and more particularly to a gift giving system which allows a recipient to select gifts of corresponding value through the gift giving system of the present invention.

### Description of Related Arts

Nowadays, people feel that gift giving has become increasingly difficult. First, gift givers often do not know what to give to the recipients. Second, if the gift received is unsuitable, dealing with it can be a troublesome task for the recipient. This is especially true during traditional festivals, such as the Mid-Autumn Festival. Mooncakes, as a traditional edible gift for the festival, are often the first choice for gift giving. However, when recipients receive an excess of mooncakes, challenges arise. Mooncakes not only have a limited shelf life, but being sweet treats, they are disliked by some people and restricted for others due to factors like blood sugar levels. Dealing with a large quantity of mooncakes becomes a burden for the recipients.

Although gift givers put considerable thought into selecting gifts, their choices are often based on their own preferences rather than the recipient's desires, likes, or real needs. As a result, once a gift is given, there is always the concern about whether the gift is appropriate or satisfying. For recipients, receiving a gift that does not meet their expectations can also be frustrating.

Gift giving, in essence, is about conveying the giver's sentiments and is a form of emotional expression. As the saying goes, “When a gift is given, the sentiment is conveyed, courtesy demands reciprocity.” However, some people equate sentiment with the monetary value of a gift, believing that the more expensive the gift, the greater the sentiment expressed. If this perception persists, it moves further away from the virtue of “small gifts, deep feelings.” Moreover, a high price tag on a gift only reflects the giver's generosity, it does not necessarily mean the recipient likes the gift or that the giver has been particularly thoughtful. If a gift is disliked by the recipient, no matter how expensive it is, the true sentiment behind the gesture may be lost. For the giver, focusing only on the price instead of choosing a gift that pleases the recipient undermines the connection between the gift and the intended sentiment. Yet, modern gift giving practices often emphasize the gift's monetary value over the expression of heartfelt emotions.

Gift wrapping is also a key aspect of gift giving. Suppliers often pay special attention to packaging to provide recipients with a sense of ceremony and to save the giver time in wrapping the gift themselves. However, such packaging is designed from the supplier's perspective and may not align with the aesthetic preferences of every giver. In other words, suppliers design packaging based solely on their own understanding. Since suppliers know even less about the recipient than the gift giver, they are unlikely to capture the emotional expression the giver wishes to convey. Thus, the packaging may not reflect the emotional significance the gift carries for the recipient. Furthermore, gift givers find it difficult to communicate their sentiments through supplier-designed packaging. Ideally, suitable packaging could enhance the giver's emotional expression, providing recipients with a clearer understanding of the giver's intentions.

For recipients, receiving certain gifts can be meaningful and worth preserving. However, under current practices, such moments can only be retained in the recipient's memory. If the recipient forgets, those precious moments are lost forever. Unfortunately, today's gift giving methods do not offer services to help preserve these cherished memories.

### SUMMARY OF THE PRESENT INVENTION

An advantage of the present invention is to provide a gift giving system for converting a received gift into value units of equal value.

Another advantage of the present invention is to provide a gift giving system which allows the converted value unit amount to be used in the gift giving system.

Another advantage of the present invention is to provide a gift giving system which enables the recording of the gift selection process.

Another advantage of the present invention is to provide a gift giving system which enables the displaying of a selection process corresponding to the gifts.

Another advantage of the present invention is to provide a gift giving system which enables the recording of the unpacking process of the gift recipient.

Another advantage of the present invention is to provide a gift giving system which provides a function of recording the unpacking process of the gift recipient for providing feedback to the gift giver.

Another advantage of the present invention is to provide a gift giving system which is used to learn the gift selection process to assist in selecting gifts.

Another advantage of the present invention is to provide a gift giving system which allows for selecting a gift in a shopping cart of the recipient within a range of converted value units.

Another advantage of the present invention is to provide a gift giving system which further provides packaging options for packaging selected packaging items.

Another advantage of the present invention is to provide a gift giving system which enables the converting of the corresponding packaging of a received gift into value units of equal value.

Another advantage of the present invention is to provide a gift giving system which allows for selecting at least one package for selection based on the selected item.

Another advantage of the present invention is to provide a gift giving system which enables self-designed packaging based on selected items.

Another advantage of the present invention is to provide a gift giving system which allows for invitation of designer designs based on selected items.

Another advantage of the present invention is to provide a gift giving system which allows for packaging a plurality of selected items in one package material.

Additional advantages and features of the invention will become apparent from the description which follows, and may be realized by means of the instrumentalities and combinations particularly pointing out in the appended claims.

According to one aspect of the present invention, a gift giving system of the present invention that can achieve the aforementioned objects and other objects and advantages comprises:
a user module which manages a group of user accounts, wherein the user management module is configured to receive a gift list and stores the gift list in a corresponding user account of a recipient, wherein the gift list unit records at least one item; and
a payment module which converts the at least one item recorded in the gift list into at least one value unit amount of equal value corresponding to the item, wherein the payment module stores the converted value unit amount in the user account corresponding to the recipient.

According to an embodiment of the present invention, the gift list records a selection process of the at least one item in the gift giving system for display, thereby assisting the recipient to determine whether to directly accept the item.

According to an embodiment of the present invention, the gift list further records a packaging material corresponding to the at least one item and a selection process of the packaging material for display, thereby assisting the recipient in determining whether to directly accept the packaging material.

According to an embodiment of the present invention, the gift list further records an electronic gift which is stored in the user module for a gift giver and the recipient to view.

According to an embodiment of the present invention, the gift selection module further comprises a digital gift module which obtains a corresponding digital gift through the gift list and stores the digital gift in the account of the recipient of the user management module.

According to an embodiment of the present invention, a feedback module is provided to allow the recipient to record an unpacking process through a camera as a feedback record to feed back to a gift giver, wherein the unpacking process of the recipient is stored in the recipient's account in the user module.

According to an embodiment of the present invention, a selection module is provided to be communicated to the feedback module, and if the gift giver receives the feedback record from the recipient, the selection module records that the item is received.

According to an embodiment of the present invention, the recipient is provided with a recipient information list which records at least one recipient name, recipient address and recipient phone number, which can be selected through the selection module.

According to an embodiment of the present invention, the selection module allows the gift giver to set a gift delivery deadline. The gift giver can set the delivery deadline directly in the interface. It is worth noting that before the delivery deadline is reached, the ownership of the gift still belongs to the gift giver, and the gift giver can modify the gift content, including but not limited to the gift itself, the packaging of the gift, the recipient, the delivery deadline, etc. Once the set delivery deadline is reached, the gift is automatically delivered. After the gift is delivered, the gift giver can no longer control the status of the gift.

According to an embodiment of the present invention, the selection module obtains a record of the corresponding item selection process of the selected item being delivered to the recipient through the user module for learning, so as to form an item selection plan for the recipient, wherein when it is necessary to select an item for the recipient, the selection module provides the item selection plan to assist the gift giver in selecting a gift.

According to an embodiment of the present invention, the selection module obtains the record of the corresponding item selection process when the item is delivered to the recipient through the user module for learning, so as to form a packaging selection plan for the recipient, wherein when it is necessary to select the packaging material for the recipient, the selection module provides the packaging selection plan to assist the gift giver in selecting the gift.

According to an embodiment of the present invention, a packaging management module is provided to be communicated to the selection module and the payment module for providing at least one packaging material for the recipient to select by analyzing the selected item. According to an embodiment of the present invention, the packaging module further comprises a packaging creation module for creating packaging materials for selection in the packaging module

According to an embodiment of the present invention, the packaging management module further comprises an item analysis module and a packaging display module, wherein the item analysis module is communicated to the packaging display module, wherein the item analysis module analyzes the selected item to obtain current item information and generates a packaging provision plan, and the packaging display module provides at least one packaging material for the recipient to select from the packaging provision plan.

According to an embodiment of the present invention, the packaging management module further comprises a packaging design module which provides a corresponding set of packaging elements for the recipient to choose from based on the information obtained from the current item, so as to provide the packaging material by combining the selected packaging elements and display the packaging material by the packaging display module.

According to an embodiment of the present invention, the packaging management module further comprises a designer design module which is configured to provide packaging requirements, and the packaging designed by a designer according to the packaging requirements is displayed through the packaging display module, wherein after the packaging is purchased, the payment module pays the designer's remuneration from the value unit amount paid for purchasing the packaging to a corresponding account of the designer.

According to an embodiment of the present invention, the item analysis module is configured to analyze the selected multiple items to obtain information of each item, so as to generate a packaging provision plan which adopts one packaging material to package the selected multiple items, wherein the packaging display module displays the corresponding packaging material according to the packaging provision plan.

According to another aspect of the present invention, a gift giving system of the present invention that can achieve the aforementioned objects and other objects and advantages comprises:
a user module which manages a group of user accounts, wherein the user management module is configured to receive a gift list and stores the gift list in a corresponding user account of a recipient, wherein the gift list unit records at least one item and at least one packaging material corresponding to the item; and
a payment module, wherein the payment module converts the at least one packaging material in the gift list into at least one value unit mount of equal value corresponding to the packaging material, and stores the converted value unit amount in the user account corresponding to the recipient.

According to an embodiment of the present invention, the gift list further records an electronic gift, and the electronic gift is stored in the user module for a gift giver and the recipient to view.

According to an embodiment of the present invention, the gift list is used to record the recipient's actions after receiving the gift, unpacking the gift, expressing gratitude, etc.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is an item selection user interface according to a preferred embodiment of the present invention.

FIG. 2 is a gift list user interface according to a preferred embodiment of the present invention.

FIG. 3 is a shopping cart user interface according to a preferred embodiment of the present invention.

FIG. 4 is an order user interface according to a preferred embodiment of the present invention.

FIG. 5 is an other gift selection user interface according to a preferred embodiment of the present invention.

FIG. 6 is a gift repackaging user interface according to a preferred embodiment of the present invention.

FIG. 7 is a system block diagram according to a preferred embodiment of the present invention.

FIG. 8 is an item selection user interface according to another preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

Those skilled in the art should understand that, in the disclosure of the present invention, terminologies of “longitudinal,” “lateral,” “upper,” “front,” “back,” “left,” “right,” “perpendicular,” “horizontal,” “top,” “bottom,” “inner,” “outer,” and etc. that indicate relations of directions or positions are based on the relations of directions or positions shown in the appended drawings, which are only to facilitate descriptions of the present invention and to simplify the descriptions, rather than to indicate or imply that the referred device or element is limited to the specific direction or to be operated or configured in the specific direction. Therefore, the above-mentioned terminologies shall not be interpreted as confine to the present invention.

It is to be understood that the term “a” or “an” should be understood as “at least one” or “one or more”, that is, in one embodiment, the number of an element may be one, while in another embodiment, the number of the element may be multiple, and the term “one” should not be understood as a limitation on the quantity.

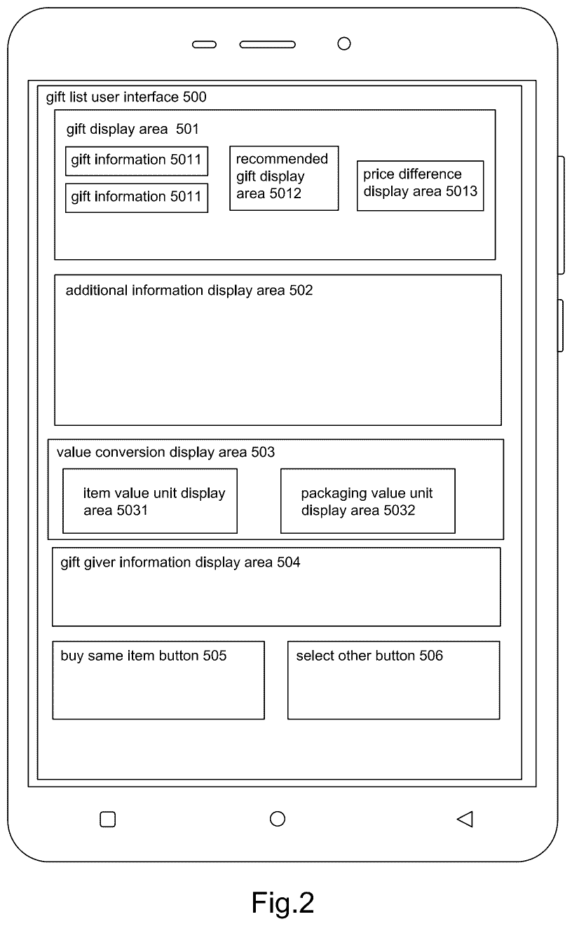

FIG. 2 illustrates a gift list user interface 500 of a preferred embodiment of the present invention. The gift list user interface 500 allows a recipient to view the information of the received gift. The gift list user interface 500 can be run on an intelligent terminal. The intelligent terminal is a computer, a smart phone, a tablet computer, etc. The gift list user interface 500 further comprises a gift display area 501 and a value conversion display area 503. The gift display area 501 is used to display gift information, such as displaying gift pictures, text introductions of gifts, and video introductions of gifts. The value conversion display area 503 displays the value unit amount of the gift in the gift giving system of the present invention.

The gift list user interface 500 further comprises an additional information display area 502 which displays additional information of the gift. The additional information of the gift comprises but is not limited to the packaging information of the gift, the gift giver's blessing to the recipient, a greeting card display, a video of the gift giver packaging the gift, etc. Preferably, the additional information display area 502 displays the gift selection process so that the recipient can experience the gift giver's intentions through the gift selection. Further, the gift information display area 501 is used to display at least one gift information 5011. Preferably, when one of the gift information 5011 is selected, the gift selection process corresponding to the gift information 5011 is displayed in the digital information display area.

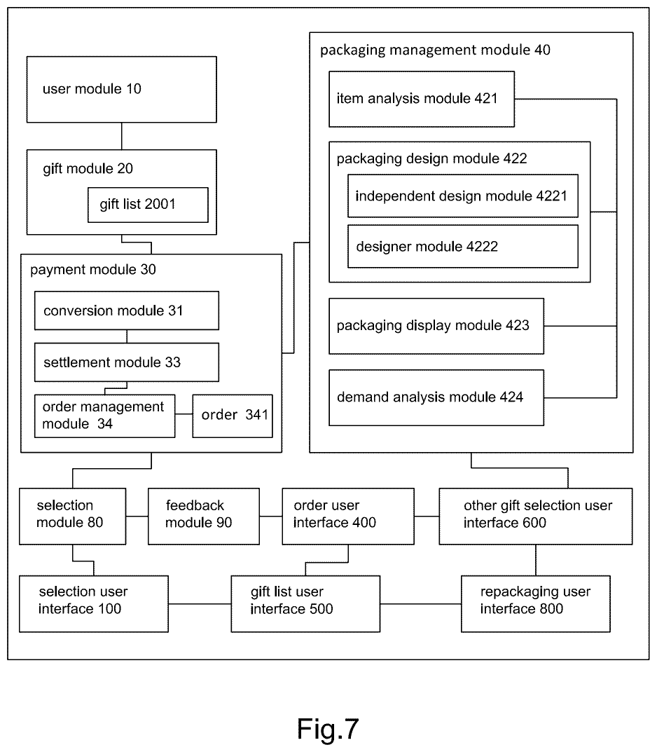

As shown in FIG. 7 and FIG. 2, in a preferred embodiment of the present invention, the gift giving system of the present invention further comprises a gift module 20 and a user module 10, wherein the gift module 20 is communicatively connected to the user module 10. The gift module 20 is communicatively connected to the gift list user interface 500. After receiving a gift list 2001, the user module 10 analyzes the gift list to obtain at least one gift information 5011. The gift module 20 displays information about the gift itself through the gift display area 501 according to the item information. It is worth mentioning that if the gift information comprises multiple items, the information of each item is displayed in the gift display area 501 as the gift information 5011. The gift list 2001 further comprises at least one digital gift. The digital gift is displayed in the additional information display area 502 of the gift list user interface 500. The digital gift comprises a digital shelf card, a blessing, a picture, a video, etc. The gift module 20 displays the gift additional information in the gift information display area 502. Preferably, if the gift additional information comprises the gift giver's blessing, the gift module 20 plays it simultaneously when the gift display area 501 displays the gift. In this way, the recipient is given a better gift receiving experience. Further, the gift list user interface 500 further comprises a gift giver information display area 504. The gift giver information display area displays information about the gift giver, such as name, last gift, etc. The recipient learns the information of the gift giver through the gift giver information display area 504. The value conversion display area 503 is used to display the equivalent value unit of the received gift in the gift giving system of the present invention. The gift giving system of the present invention further comprises a payment module 30. The payment module 30 obtains the item information included in the item list according to the gift list 2001. The payment module 30 converts the value units according to the item information. The payment module 30 displays the converted value unit amount in the value conversion display area 503. For example, a gift giver purchases a gift of 500 value units in the gift giving system of the present invention, and the payment module 30 converts the gift into value units of the same amount, that is, 500 value units, and displays 500 value units in the value conversion display area 503.

If the gift giver further selects packaging, the gift list 2001 received by the gift recipient further comprises packaging information. The packaging corresponding to the packaging information is displayed in the additional information display area 502. Further, the additional information display area 502 displays the packaging process of the item. The gift recipient can better understand the gift giver's intentions through the gift giver's packaging process of the gift. The payment module 30 further converts the packaging information into value units of corresponding value. The value conversion display area 503 displays the gift value unit and the packaging value unit respectively. In a preferred embodiment of the present invention, the value conversion display area 503 further comprises an item value unit display area 5031 and a packaging value unit display area 5032. The item value display area 5031 displays the converted item value unit amount. The packaging value unit display area 5032 is used to display the converted packaging value unit amount. It is worth mentioning that the gift list user interface 500 further comprises a buy same item button 505. When the buy same item button 505 is clicked, the buy same item function in the gift giving system of the present invention is activated. Specifically, the payment module 30 selects the product corresponding to the gift from the gift module 20 according to the gift list. The payment module 30 further obtains the information of the corresponding recipient in the gift list through the user module 10, and generates a gift order with the corresponding gift information and/or the corresponding packaging information. After the gift order is confirmed by the recipient, the payment module 30 pays the gift order with the converted value unit. The gift giving system of the present invention designates a packaging in the gift list to package the gift. The gift can be delivered to the physical address of the recipient provided by express delivery.

It is worth mentioning that the gift giving system of the present invention further comprises a feedback module 90. The feedback module 90 is communicatively connected to a camera, and the intelligent terminal with a camera records the process of unpacking through the camera to feedback to the gift giver, so as to feedback the mood of the gift receiver receiving the gift to the gift giver. It is worth mentioning that the process of the gift giver selecting items for the gift recipient and/or the process of selecting packaging materials are respectively stored in the account of the gift recipient and the account of the gift giver corresponding to the gift giver and the gift recipient. The gift giving system of the present invention further comprises a selection module 80. If the gift recipient receives the gift of the gift giver, the selection module 80 marks the gift list corresponding to the gift, the corresponding gift selection process, and/or the packaging selection process through the user module 10, and stores them in the corresponding accounts of the gift recipient and the gift giver respectively. The selection module 80 learns the marked gift selection process to form a gift selection plan. When it is necessary to select a gift for the gift giver, the gift selection plan provides assistance to the gift giver. The selection module 80 learns the marked packaging selection process to form a packaging selection plan. When it is necessary to select packaging for the gift of the recipient, the packaging selection plan assists the gift giver in selecting packaging. It is worth mentioning that the selection module 80 optimizes the gift selection plan by continuously learning the different gift selection videos of the gift giver. The selection module 80 optimizes the packaging selection plan by continuously learning the different packaging selection videos of the gift giver. It is worth mentioning that the selection module 80 sets a threshold. The selection module 80 processes the time, number of times, and/or the interval between two gifts received by the recipient to form a reference value. When the reference value reaches or exceeds the threshold, the selection module 80 chooses to deliver the gift selected by the gift giver directly to the recipient.

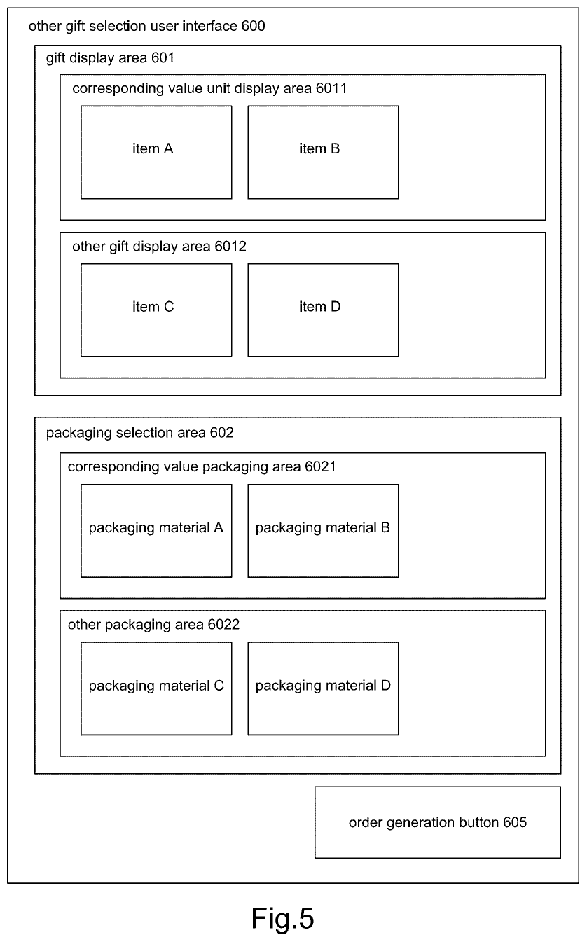

The gift list user interface 500 further comprises a select other button 506. When the select other button 506 is clicked, an other gift selection user interface 600 of the gift giving system of the present invention is displayed, as shown in FIG. 5. The recipient selects a gift through the other gift selection user interface 600. The other gift selection interface further comprises a gift display area 601. The gift display area displays gifts for selection. The gift display area 601 further comprises a corresponding value unit display area 6011 for displaying items with the same value amount as the received gift. The gift module 20 obtains the value unit amount of the received gift from the payment module 30. The gift module 20 selects items with the same value unit amount as the received gift from the items according to the received value unit amount, and displays them in the corresponding value unit display area 6011. Furthermore, if the recipient receives more than one item. The payment module 30 converts the value unit of the same amount for each item respectively. The gift module 20 selects items of corresponding value units respectively for display in the corresponding value unit display area 6011. Further, the gift module 20 obtains information of items in a shopping cart 300 in the recipient's account from the user module 10. The gift module 20 combines the item information in the recipient's shopping cart and selects items of value units corresponding to the received items in the recipient's shopping cart to display in the corresponding value unit display area 6011. In another preferred embodiment of the present invention, the gift module 20 further selects recently frequently browsed gifts in the corresponding value gifts based on the gifts of the same value units as the received gift to display in the corresponding value gift display area 6011. It is worth mentioning that the corresponding value unit display area 6011 can provide a display of gift combinations. Specifically, the corresponding value gift can be a single gift with the same number of value units as the received gift, or a total amount of value units of multiple gifts corresponding to the amount of the received gift. In another preferred embodiment of the present invention, the gift module 20 obtains the gift selection scheme and selects a corresponding gift based on the gift selection scheme. The gifts of corresponding value selected by the gift module 20 are displayed in the corresponding value unit display area 6011.

The gift display area 601 further comprises an other gift display area 6012. The other gift display area 6012 is used to display items with a value unit amount that is not corresponding to the received item. Further, the gift module 20 selects items within the value unit amount of the received item to be displayed in the other gift display area 6012. In another preferred embodiment of the present invention, the gift module 20 obtains the gift selection scheme and selects a corresponding gift based on the gift selection scheme. The gifts with different value amounts selected by the gift module 20 are displayed in the other gift display area 6012. Further, the other gift selection interface 600 further comprises a packaging selection area 602. In the packaging selection area, the recipient selects the corresponding packaging according to the selected gift. The packaging selection area 602 further comprises a corresponding value packaging area 6021 and an other packaging area 6022. The packaging displayed in the corresponding-value packaging area 6021 has the same amount of value units as the packaging corresponding to the gift received by the recipient. Preferably, the gift module 20 allows for selecting corresponding packaging materials with the same amount of value units according to the selected gift, and displays them in the corresponding-value packaging area 6021. The other packaging area 6022 displays other packaging. The other packaging refers to packaging whose value units are not corresponding to the value units of the packaging of the gift of the recipient. The recipient can select other packaging in the other packaging area 6022. Preferably, the gift display module 20 can be used to select other packaging according to the selected gift.

It is worth mentioning that after the gift is selected, the packaging is recommended and selected through the packaging selection scheme formed by the selection module 80. Packaging materials with corresponding value unit amount are placed in the corresponding value packaging area 6021, and packaging materials with unequal value unit amount are placed in the other packaging area 6022.

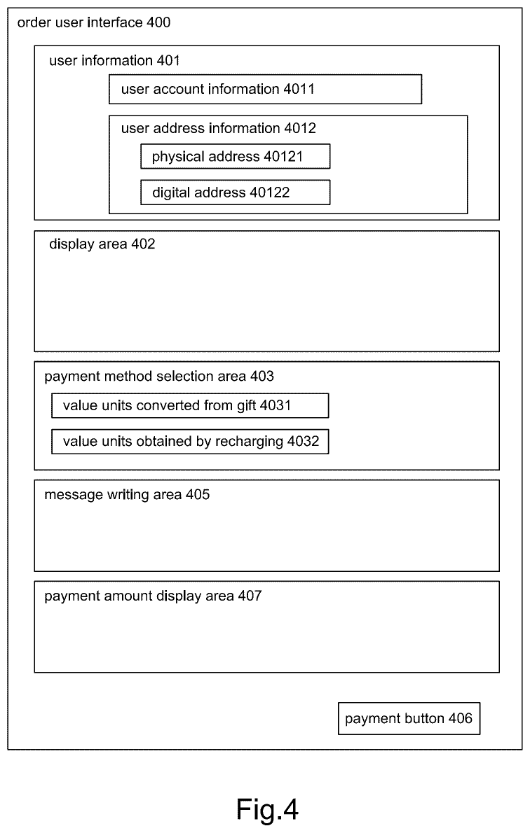

The other gift selection interface 600 further provides an order generation button 605. When the order generation button is clicked, the gift module 20 generates an order 341 according to the information of the gift selected in the other gift selection interface 600, the selected packaging information and the communication information of the recipient. The user interface of the order 341 is displayed as an order user interface 400, as shown in FIG. 4. The order user interface 400 further comprises a user information 401. The user information displays user information, such as user account information 4011 and user address information 4012. Further, the user address information 4012 further comprises a physical address 40121 and a digital address 40122. The physical address information is used to receive the gift. The digital address 40122 is used to receive digital content, such as electronic greeting cards, videos and/or audio content. The digital address can be implemented as an account, phone number or email of the gift delivery system of the present invention. The order user interface 400 further comprises a display area 402 for displaying the selected gift and/or packaging. The order user interface 400 further comprises a payment method selection area 403 for selecting payment by value units 4031 converted from gift and payment by value units 4032 obtained by recharging. Preferably, the gift giving system of the present invention preferentially uses the gift-converted value units 4031 for payment. When the gift-converted value units 4031 are insufficient for payment, the value units 4032 obtained by recharging are used for payment. The order user interface 400 further comprises a payment amount display area 407 for displaying the amount of payment for the order. The order user interface 400 further comprises a message writing area 405 for writing a message. It is worth mentioning that the message written in the message writing area is written into a selected digital card as the message. The order user interface 400 further comprises a payment button 406. When the payment button 406 is clicked, payment is executed. The value unit of the user account of the recipient is used for payment. Preferably, payment is first made from the converted value unit of the gift of the recipient. After payment, the gift delivery system of the present invention delivers the gift according to the physical address of the recipient. It is worth mentioning that the message written in the message writing area 405 is displayed in the additional information display area of the gift list 2001.

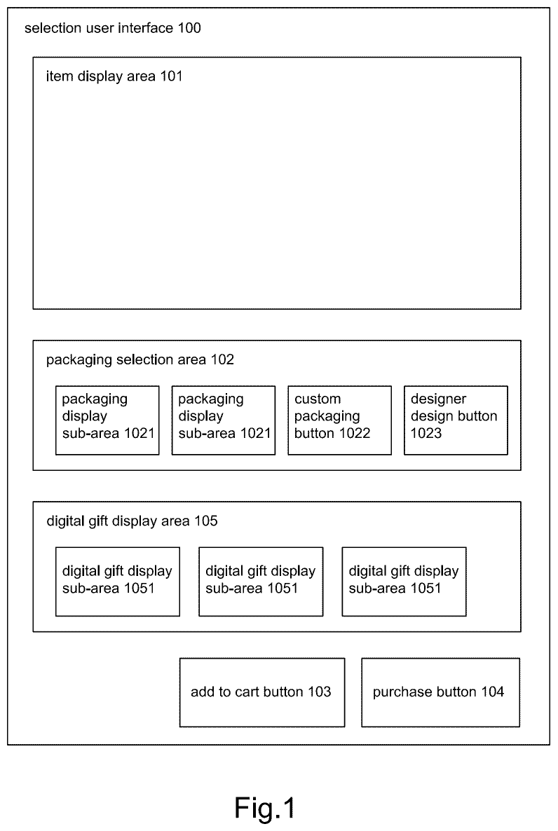

FIG. 1 illustrates a selection user interface 100 for selecting a gift in a preferred embodiment of the gift giving system of the present invention. The selection user interface 100 comprises an item display area 101 and a packaging selection area 102. The item display area is used to display the gift selected by the user. The item display area 101 displays the gift, and the packaging selection area 102 is used to select the packaging corresponding to the gift displayed in the item selection area. Specifically, when the item display area 101 displays a gift, the packaging selection area 102 provides multiple packaging materials suitable for the item. That is, the packaging selection area 102 is further provided with multiple packaging display sub-areas 1021 for displaying multiple packaging suitable for the displayed gift. The selection user interface further comprises an add to cart button 103 and a purchase button 104. When the add to cart button 103 is triggered, the selected item and the selected packaging are put into the shopping cart. If the purchase button 104 is triggered, the order user interface 400 is displayed. The payment is made through the payment button 406 of the order user interface 400. Further, the selection user interface 100 further comprises a digital gift display area 105. The digital gift display area 105 is used to display digital gifts. The digital gift display area 105 further comprises at least one digital gift display sub-area 1051. Each digital gift display sub-area 1051 is used to display a digital gift. The digital gift can be a digital version corresponding to the selected gift. It can also be a digital greeting card. It can also be a digital item such as a photo or video. That is to say, in the selection user interface 100, the user can select a gift, a package suitable for the selected gift, and an electronic gift at the same time. It is worth mentioning that the process of the gift giver selecting an item is recorded by the selection module 80. The process of the gift giver selecting an item is displayed in one of the digital gift display areas. The selection module 80 further records the process of selecting a packaging material corresponding to the item. The process of the gift giver selecting a packaging material is displayed in one of the digital gift display areas 105. Furthermore, the gift giver uses a camera or a smart phone to shoot the process of wrapping the gift, and the process of wrapping the gift can be displayed in the digital gift display area 105. The gift giver 105 selects the content to be sent through the digital gift display area 105. The digital gift display area 105 can be divided into a group of digital gift sub-display areas 1051. Each digital gift sub-display area 1051 displays a digital gift, or a gift selection process, or a packaging selection process, or a gift packaging process, etc. It is worth mentioning that for the recipient, the process of unpacking becomes a ritual. Furthermore, combined with the display of digital gifts, the ritual sense of unpacking the gift is further enhanced. In other words, the ritual sense of unpacking the gift is reflected through gift packaging and/or digital gifts.

FIG. 5 illustrates a repackaging user interface 800 of a preferred embodiment of the gift giving system of the present invention. The repackaging user interface 800 comprises a group of selected item display areas 801 and a repackaging display area 802. The selected gift display area is used to display items to be repacked. The repackaging display area 802 displays packaging materials used to pack the selected gifts. The repackaging display area 802 further comprises at least one combined packaging display area 8021. The combined packaging display area 8021 is used to display packaging materials for accommodating multiple selected items. The item repackaging user interface 800 further comprises a submit button 804. After the packaging materials of the item are selected, an order 341 is generated by clicking the submit button 804. The user pays according to the order. It is worth mentioning that if the packaging materials provided by the repackaging display area 802 cannot meet the needs of the user. The repackaging user interface 800 further comprises a packaging material demand submission area 803. The packaging demand submission area 803 allows at least one packaging designer to obtain packaging demands. The packaging designer designs corresponding packaging according to the packaging demands. If the corresponding packaging is selected by the user, the user will pay the designer's design fee when paying the order. It is worth mentioning that the items selected by the gift giver may have original packaging. That is, in the repackaging user interface 800, the gift giver can select items with packaging and repack items without packaging.

FIG. 7 illustrates a schematic diagram of the system framework of the gift giving system of the present invention. The gift giving system of the present invention further comprises a user module 10, a gift module 20 and a payment module 30. The user module 10 manages the user's account. The user module 10 records the basic information of the user. It is worth mentioning that the basic information of the user comprises the user's contact information, such as telephone number, address, etc. It is worth mentioning that the address comprises a physical address and a digital address. The physical address refers to an address that can receive mail. The digital address refers to an address that can receive electronic information, such as an email address, a mobile phone number, etc. The user module 10 further manages the amount of the value unit of the user in the gift giving system of the present invention. The user module 10 further manages the gift list 2001 received by the user account. The gift list 2001 corresponds to the process of selecting a gift, the process of selecting a package and the process of packaging a gift, which are stored in the sender's account and the recipient's account of the user module 10 respectively.

The gift module 20 manages the items for user selection in the gift giving system of the present invention. The gift module 20 records the basic information of the items. Such as the function of the item, the parameters of the item, matters that need to be noted when transporting the item, etc. The gift module 20 further records matters that need to be noted when selling, displaying and transporting the item. When the user selects an item by selecting the selection user interface 100, the gift module 20 displays the item through the item display area 101. The payment module 30 is communicatively connected to the user module 10 and the gift module 20 respectively. The payment module 30 is used to convert the received gift into the value unit amount used by the gift giving system of the present invention. The payment module 30 records the amount in the account corresponding to the user module 10. Further, the payment module 30 is used to convert the selected package into the value unit amount used by the gift giving system of the present invention.

The gift giving system of the present invention further comprises a packaging management module 40. The packaging management module 40 manages packaging materials. The packaging materials are used to package the items of the gift giving system of the present invention. As shown in FIG. 1, when the selection user interface 100 is used for gift selection, the gift module 20 displays the items in the item display area 101. When one of the items is displayed in the item display area 101, the packaging management module 40 obtains information of the item currently displayed in the item display area 101 from the gift module 20. For example, the name, function, basic parameters, and precautions of the item. The basic parameters of the item refer to the length, width, height, material, performance parameters, etc. of the item. Precautions, indicating fragile, fresh-keeping, placement direction, etc. The packaging management module 40 selects the packaging corresponding to the item according to the item parameters for display in the packaging display area. It is worth mentioning that at least one type of packaging material is displayed in the packaging display area 102 for selection. That is to say, in the gift giving system of the present invention, an item can provide multiple packaging materials for selection.

Specifically, the packaging management module 40 further comprises an item analysis module 421 and a packaging display module 423. The item analysis module 421 obtains the item information displayed in the current item display area 101 from the gift module 20. The item analysis module 421 performs analysis based on the obtained item information. For example, the analysis is performed based on the size of the selected gift, the storage requirements of the selected gift, the transportation requirements of the selected gift, the culture reflected by the selected gift, the usage requirements of the selected gift, the style requirements of the selected gift, etc. The item analysis module 421 selects one or more requirements for packaging and sends them to the packaging display module 423. The packaging display module 423 selects corresponding packaging material to display in the packaging display area 102 according to one or more requirements for packaging. Taking tea as an example of the selected item, the analysis process of the item analysis module 421 is further explained. The item displayed in the item display area 101 is tea. The item analysis module 421 obtains the characteristics of the tea currently displayed in the item display area through the gift module 20. The item analysis module 421 analyzes the following points that need to be noted when packaging tea: tea is afraid of high temperature, moisture, oxygen, light and odor. For the characteristics of being afraid of high temperature, the packaging needs to be kept cool or refrigerated. For the characteristics of being afraid of moisture, the packaging needs to be sealed and dried. For the characteristics of being afraid of oxygen, the tea needs to be sealed, vacuumed and refrigerated. For the characteristics of being afraid of light, the packaging needs to be opaque. For being afraid of odor, the packaging needs to be sealed. The item analysis module 421 obtains the basic characteristics that the packaging of tea needs to be sealed, opaque and dry through the above analysis. Further, the packaging of tea also needs to be vacuumed and refrigerated. The item analysis module 421 further identifies the type of tea. For example, the tea shown is green tea or fragrant oolong tea. This type of tea is easily oxidized by oxygen and needs to be stored in a cool place. The corresponding packaging can be sealed bags, etc. For Tieguanyin and Taiwan high mountain oolong granules, vacuum packaging is used for the corresponding packaging, or porcelain jars with good sealing properties are selected, or aluminum foil bags are sealed. For white tea, black tea, and Pu'er tea, which need to maintain air permeability without being damp, pottery jars and purple clay jars can be selected as packaging materials. The use of tea can also be selected as packaging. For example, to make tea conveniently, the amount of a cup of tea can be used as a sub-package, or the tea can be packaged separately according to the amount of a cup of tea. The item analysis module 421 analyzes the displayed tea to obtain packaging data. The packaging display module 423 selects at least one package material for packaging the tea according to the packaging data. For example, ordinary sealed bag packaging, tin foil sealed packaging, sealed porcelain jar packaging, and independent small bag packaging. The above-mentioned ordinary sealed bag packaging, tin foil sealed packaging, sealed porcelain jar packaging, and independent small bag packaging are displayed in the packaging selection area 102. It is worth mentioning that different packages have different prices. That is, the price of a gift comprises the price of the item and the price of the packaging. In the case of the same item, the selected packaging is different, and the price of the gift is also different.

If the add to cart button 103 is clicked, the selected tea and the selected packaging are added to the shopping cart. If the purchase button 104 is clicked, an order is generated according to the selected tea and the selected packaging. The price of the order is determined by the price of the item and the price of the selected packaging. The account management module 10 manages the shopping cart corresponding to the user account. The payment module 30 manages the items in the shopping cart and the corresponding prices of the packaging.

Furthermore, the selection user interface 100 further comprises a digital gift display area 105. The digital gift display area 105 is used to display at least one digital gift. In a preferred embodiment of the present invention, the digital gift display area 105 further comprises at least one digital gift sub-display area 1051 for displaying digital gifts. It is worth mentioning that the digital gift display area 105 recommends digital gifts according to the selected gift. Taking tea as an example, when the gift module 20 displays tea in the item display area 101, the gift module 20 displays pictures, animations, e-books, videos, games or courses related to tea in the digital gift display area for the gift giver to choose. In this way, when the gift giver selects a tea, he or she also selects the introduction and brewing method of the tea, as well as the corresponding packaging design concept. The recipient can also feel the gift giver's intention from the electronic gift. The gift giver can select multiple digital gifts in the digital gift display area 105. It is worth mentioning that the process of the gift giver selecting tea leaves will be recorded and displayed in the digital gift display area 105. The process of the gift giver selecting packaging for the tea leaves will also be recorded and displayed in one of the digital gift display areas 105.

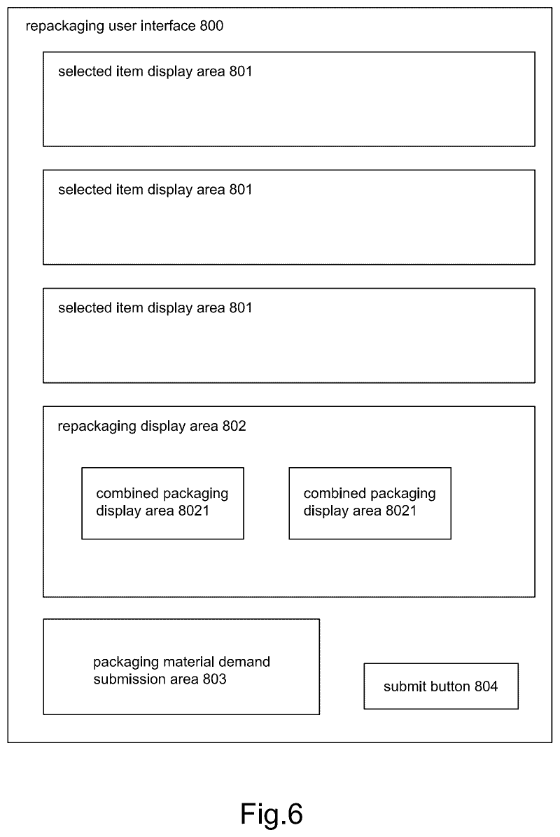

It is worth mentioning that if the gift giver selects multiple types of tea, the gift repackaging user interface 800 can be used to perform repackaging operations. As shown in FIG. 6, a packaged tea is displayed in one of the selected gift display areas 801, and an unpackaged tea is displayed in another selected gift display area 802. The item analysis module 421 analyzes the packaged tea displayed in one of the selected gift display areas 801 and the unpackaged tea displayed in another selected gift display area 802. The packaging management module 40 further comprises a demand analysis module 424. The demand analysis module 424 obtains the gift giver's demand for packaging from the packaging demand submission area 805. For example, the gift giver uses small bottles to package the selected two types of tea. The item analysis module 421 analyzes the characteristics of the two types of tea respectively. The packaging display module 423 selects corresponding packaging materials for display according to the characteristics of the two types of tea detected by the item analysis 421. If one type of tea needs to be stored in an opaque manner, the packaging display module 423 selects an opaque small bottle. If another type of tea needs good air permeability, the packaging display module 423 preferably selects a small pottery jar. Furthermore, the packaging display module 423 further analyzes how to form a package with multiple small pottery jars. The packaging display module obtains the packaging selection scheme from the selection module, and selects each package according to the packaging scheme. It is worth mentioning that the packaging display module 423 selects the packaging of tea among the gifts received by the recipient through the selection module, and generates a packaging analysis result. The packaging display module 423 searches for the corresponding packaging material according to the packaging analysis result and displays it in the repackaging display area 802. If the packaging display module 423 re-outputs a packaging requirement according to the packaging analysis result, it is then submitted to the packaging requirement submission area 803 as a packaging requirement submission. The packaging designer can obtain the packaging design requirement through the packaging requirement submission area 803. After the packaging designer has designed the packaging according to the packaging design requirements, it can be displayed in the repackaging display area 802. It is worth mentioning that multiple packaging designers can display their designed packaging in the repackaging display area 802. The repackaging display area 804 can be divided into multiple combined packaging display areas 8021, each of which displays the design of a designer.

After the purchase button is clicked, the payment module 30 generates an order 341. Specifically, the payment module 30 further comprises an order management module 34, a settlement module 33 and a conversion module 31. The order management module 34 manages the order 341. The order management module 34 obtains the user information from the account management module 10 and displays the user information 401 in the order user interface 400. The item information and electronic gift information obtained by the order management module 34 from the item management module 34 are displayed in the display area 402. The order management module 34 provides payment method selection in the payment method selection area by the following to manners: one is the gift conversion value unit amount and the other is the recharge value unit amount. The user can choose the above two payment methods to pay. It is worth mentioning that the default payment method is the payment method of the gift conversion value unit amount. If the gift conversion value unit amount is insufficient to pay, the gift conversion price unit amount is used first for payment, and the difference is paid by using the recharge value unit amount. The gift conversion value unit amount 4031 in the payment method selection area 403 displays the gift conversion value unit amount. The recharge value unit amount 4032 displays the recharged value unit amount. Further, if the selected digital gift comprises a digital gift card, the order user interface 400 further displays the message writing area 405 for the user to write a message to the recipient in the message writing area 405. The settlement module 33 displays the amount to be paid for the order in the payment amount display area 407. When the payment button 406 is clicked, the settlement module 33 performs settlement. The value unit in the user account is used to pay the order 341. It is worth mentioning that if the order 341 comprises the design fee of the packaging designer, the packaging designer's fee is listed in the display area 402. At the time of settlement, the settlement module 33 pays the packaging designer's fee.

After the order 341 is paid, the gift module 20 generates a corresponding gift list 2001. The gift module 20 sends the gift list 2001 to the recipient through the digital address of the recipient. The recipient receives the digital gift through the digital address. At the same time, the account management module 10 stores the digital gift in the recipient's account. The conversion module 31 converts the items and the packaging in the order into corresponding value unit amounts, and the settlement module 33 transfers the corresponding value unit amounts to the recipient's account. Further, the settlement module 33 transfers the corresponding value unit amounts to the gift conversion value unit amounts in the recipient's account. The item module 10 displays the gifts received by the recipient in the gift display area 501. The gift display area 510 can display the received gifts and the corresponding selected packaging. The item module 10 further displays the received digital gifts in the digital information display area 502. The electronic greeting card and message received by the recipient are also displayed in the digital information display area 502. The conversion module 31 displays the value units corresponding to the items and/or the packaging materials in the order 341 in the value conversion display area 503. The account management module 10 displays the information of the gift giver in the gift giver information display area. When the purchase button 505 is activated, the payment module 30 generates another order 341 according to the gifts and their corresponding packaging materials displayed in the gift list user interface 500. The account management module 10 provides the information of the recipient, including account information and physical address information, to another order 341. The settlement module 33 pays the value units of the same amount as the gift and its corresponding packaging materials from the value unit amount of the recipient's account to pay for another order 341. After the payment of the other order 341 is completed, the gift is packaged in the selected packaging materials and then sent to the physical address of the recipient for the recipient to receive. When the select other button is triggered 506, a select other user interface 600 is displayed.

The gift module 20 provides item information to the other gift selection interface user interface 600. Further, the gift module 20 classifies items according to the value unit amount, and the gift module 20 displays the value units of the same amount corresponding to the received gift in the gift display area 601. Gifts with value units that are not corresponding to the received gift are displayed in the other commodity display area 602. The packaging display module 423 classifies packaging materials according to the value unit amount. The packaging display module 423 displays packaging materials with the same value unit amount as the packaging material corresponding to the received gift in the same value unit packaging area. Packaging materials with unequal value unit amounts corresponding to the received gift are displayed in the other packaging recommendation area 604. After the gift and the corresponding packaging material are selected, another order 341 is generated by clicking the order generation button 605. The address of the order is the physical address of the recipient. The payment module 30 uses the account of the recipient to pay the value units. After the recipient pays for the other order 341, the selected gift is packaged in the selected packaging and sent to the recipient's physical address.

Through the above-mentioned method, the digital gift, the gift selection process, the packaging selection process, and/or the gift packaging process reflect the intention of the gift giver in selecting the gift. Through the display of the gifts, the recipient receives the intention of the gift giver. Furthermore, the gift selected by the gift giver is not directly sent out, but converted into value units of a determined amount corresponding to the gift and stored in the account of the recipient. The recipient chooses whether to accept the gift from the gift giver according to his own needs. If the gift selected by the gift giver is not what the recipient needs, the recipient can select the items he needs. If the value unit of the item selected by the recipient is higher than the value unit of the item sent by the gift giver, he only needs to make up the difference. In this way, the recipient can choose his own item, and the intention expressed by the gift giver is also conveyed to the recipient. The gift giving system of the present invention solves the problem of how the gift giver expresses his or her intentions and how the gift recipient handles the gift.

Furthermore, the gift giving system of the present invention further provides packaging design. Specifically, the packaging management module 40 further comprises a packaging design module 422. The packaging design module 422 provides the gift giver with the possibility of designing packaging on his or her own or asking a designer to design packaging. The packaging design module 422 further comprises an independent design module 4221 and a designer module 4222. The independent module 4221 provides the gift giver with the possibility of designing packaging. The independent module 4221 defines packaging as a container and a filler. Preferably, the container is a box body. The filler is placed in the box body, and the article is placed in the filler to fix the position of the article in the box body through the filler. The packaging further comprises at least one decoration. The decoration is arranged on the outer surface of the box body. The packaging further comprises a card for the gift giver to write a message on the card. Through the custom packaging button 1022 in the packaging selection area 102 of the selection user interface 100, the sender and the recipient can select the box body, the filler and the decoration. The packaging selection area 102 further comprises a designer design button 1023. Through the designer design button 1023, the gift giver provides the packaging requirements of the item to multiple designers. Each designer designs according to the gift giver's packaging requirements. The packaging designed by each designer can be displayed in the packaging selection area 102 for the gift giver to choose. Specifically, when the ask designer to design button 1023 is clicked, the designer design module 422 provides a demand provision interface for the gift giver to make a request. Each designer obtains the gift giver's demand for packaging through the demand provision interface. Each designer designs the corresponding packaging according to the gift giver's demand for packaging. Through the designer design module 422, each designer places the designed package in the package selection area 102 for the gift giver to choose. It is worth noting that if the package selected by the gift giver is designed by the designer, after the gift giver pays, the settlement module 33 allocates the design fee obtained by the designer to the corresponding account of the designer.

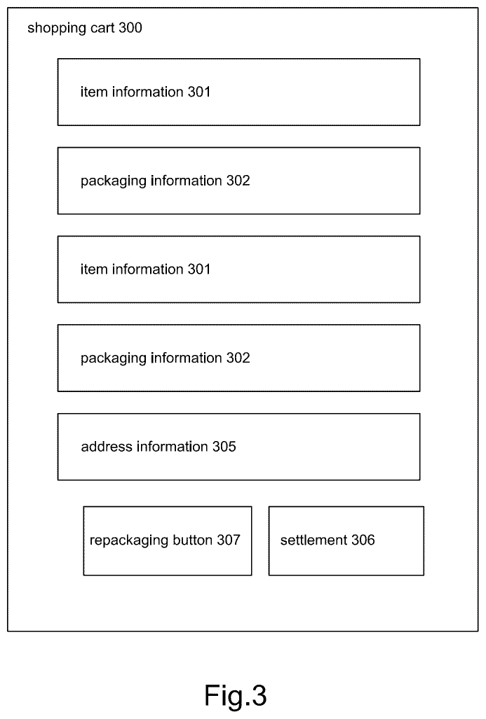

FIG. 3 shows a shopping cart interface 300 of a preferred embodiment of the present invention. The shopping cart interface 300 displays at least one item information 301 and corresponding packaging information 302. The shopping cart interface 300 further comprises an address information 305 for displaying the address that can be delivered. The shopping cart interface 300 further comprises a repackaging button 307. When the repackaging button 307 is clicked, the items selected in the shopping cart are repacked. Specifically, when the repackaging button 307 is clicked, the item analysis module 421 obtains the information of the selected items from the shopping cart interface 300. The item analysis module 421 determines the number of the selected items that need to be repacked and the characteristics of the selected items. The item analysis module 421 classifies the selected items according to their types. For example, among the selected items, those belonging to fruits are classified into one category; those belonging to stationery are classified into one category; those belonging to tea sets are classified into one category, and so on. According to the number of the selected items in the same category after classification and the characteristics of the category, the item analysis module 421 selects at least one package to recommend to the user according to the characteristics of the category. Specifically, the item analysis module 421 analyzes the appearance, packaging structure, packaging decoration and other elements of the selected package to analyze the package so as to provide a corresponding package for the selected item.

Furthermore, the gift giver can provide a repackaging requirement through the repackaging button 307. For example, the gift giver proposes to package the selected tea leaves and tea sets as a gift. The item analysis module 421 analyzes the capacity of the tea leaves and the characteristics of the tea leaves of this category and the category and characteristics of the tea sets, and selects corresponding packaging materials for recommendation. If the selected tea leaves and tea sets are mostly collectible, the item analysis module 421 selects packaging materials based on the style and requirements of the collection to provide at least one packaging material for the gift giver to choose. If the selected tea leaves and tea sets are for daily drinking, the item analysis module 421 selects packaging that can package the tea leaves separately into small packages and then package them together with the tea sets, and then recommends them to the gift giver. It is worth mentioning that the self-design and designer design methods are also applicable to item repackaging.

It is worth mentioning that the conversion module 31 further allows conversion of items. As shown in FIG. 2, in the gift list user interface 500, the gift display area 501 further comprises a gift information 5011 and a recommended gift display area 5012. The gift module 20 displays the received gift in the received gift display area gift of the gift information 5011. The conversion module 31 converts the received gift into a value unit of a corresponding amount and stores it in the corresponding account of the recipient. The conversion module 31 further obtains the recipient's shopping cart information from the account management module of the user module 10. If the shopping cart information of the recipient contains the received gift, the conversion module 31 displays the received gift in the shopping cart information of the recipient in the recommended gift display area 5012. The recipient learns through the gift information display area that the item he or she selected is selected by the gift giver, so the recipient can better understand the intention of the gift giver. The recipient purchases the gift given by the gift giver again through the buy same item button 505. If the shopping cart information of the recipient does not contain the received gift, the conversion module 31 further selects a gift with a value unit amount in a preset value unit amount range in the shopping cart of the recipient according to the value unit corresponding to the amount of the received gift in a preset value unit amount range. The gift is displayed in the recommended gift display area 5012 for the recipient to choose. It is worth mentioning that the gift display area 501 further comprises a price difference display area 5013. The conversion module 31 displays the difference between the value unit amount of the received gift and the value unit amount of the gift displayed in the recommended gift display 5012 in the price difference display area 5013 to facilitate the recipient to select a gift.

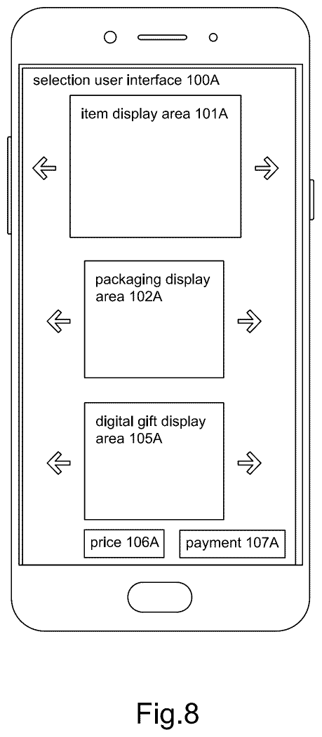

FIG. 8 illustrate a selection user interface according to an alternative mode of the present application. The selection user interface 100A further comprises an item display area 101A, a packaging display area 102A and a digital gift display area 105A. The item display area 101A is for displaying at least one item. The packaging display area 102A displays packaging materials corresponding to the items displayed in the item display area 101A. In other words, the packaging materials displayed in the packaging display area 102A is suitable for the items displayed in the item display area 101A. The digital gift display area 105A is arranged for displaying digital gifts, which are suitable for the items displayed in the item display area 101A. The packaging materials displayed in the packaging display area 102A and the digital gifts displayed in the digital gift display area are defined as personalized items. It is worth mentioning that personalized items will not be valued after being sold in the gift giving system of the present application. They will not be recycled by the gift giving system of the present application. It is worth mentioning that if the user has personalized the purchased items. This gift giving system does not evaluate or recycle personalized products for the personalized platform.

One skilled in the art will understand that the embodiment of the present invention as shown in the drawings and described above is exemplary only and not intended to be limiting. It will thus be seen that the objects of the present invention have been fully and effectively accomplished. The embodiments have been shown and described for the purposes of illustrating the functional and structural principles of the present invention and are subject to change without departure from such principles.

1. A gift giving system, comprising:
a user module which manages a group of user accounts, wherein the user management module is configured to receive a gift list and stores the gift list in a corresponding user account of a recipient, wherein the gift list unit records at least one item; and
a payment module which converts the at least one item recorded in the gift list into at least one value unit amount of equal value corresponding to the item, wherein the payment module stores the converted value unit amount in the user account corresponding to the recipient.

2. The gift giving system, as recited in claim 1, wherein the gift list records a selection process of the at least one item in the gift giving system for display, thereby assisting the recipient to determine whether to directly accept the item.

3. The gift giving system, as recited in claim 1, wherein the gift list further records a packaging material corresponding to the at least one item and a selection process of the packaging material for display, thereby assisting the recipient in determining whether to directly accept the packaging material.

4. The gift giving system, as recited in claim 3, wherein the gift list further records an electronic gift which is stored in the user module for a gift giver and the recipient to view.

5. The gift giving system, as recited in claim 3, further comprising a feedback module which allows the recipient to record an unpacking process through a camera as a feedback record to feed back to a gift giver, wherein the unpacking process of the recipient is stored in the recipient's account in the user module.

6. The gift giving system, as recited in claim 5, further comprising a selection module which is communicated to the feedback module, and if the gift giver receives the feedback record from the recipient, the selection module records that the item is received.

7. The gift giving system, as recited in claim 6, wherein the selection module obtains a record of the corresponding item selection process of the selected item being delivered to the recipient through the user module for learning, so as to form an item selection plan for the recipient, wherein when it is necessary to select an item for the recipient, the selection module provides the item selection plan to assist the gift giver in selecting a gift.

8. The gift giving system, as recited in claim 7, wherein the selection module obtains the record of the corresponding item selection process when the item is delivered to the recipient through the user module for learning, so as to form a packaging selection plan for the recipient, wherein when it is necessary to select the packaging material for the recipient, the selection module provides the packaging selection plan to assist the gift giver in selecting the gift.

9. The gift giving system, as recited in claim 6, further comprising a packaging management module which is communicated to the selection module and the payment module for providing at least one packaging material for the recipient to select by analyzing the selected item.

10. The gift giving system, as recited in claim 9, wherein the packaging management module further comprises an item analysis module and a packaging display module, wherein the item analysis module is communicated to the packaging display module, wherein the item analysis module analyzes the selected item to obtain current item information and generates a packaging provision plan, and the packaging display module provides at least one packaging material for the recipient to select from the packaging provision plan.

11. The gift giving system, as recited in claim 10, wherein the packaging management module further comprises a packaging design module which provides a corresponding set of packaging elements for the recipient to choose from based on the information obtained from the current item, so as to provide the packaging material by combining the selected packaging elements and display the packaging material by the packaging display module.

12. The gift giving system, as recited in claim 11, wherein the packaging management module further comprises a designer design module which is configured to provide packaging requirements, and the packaging designed by a designer according to the packaging requirements is displayed through the packaging display module, wherein after the packaging is purchased, the payment module pays the designer's remuneration from the value unit amount paid for purchasing the packaging to a corresponding account of the designer.

13. The gift giving system, as recited in claim 11, wherein the item analysis module is configured to analyze the selected multiple items to obtain information of each item, so as to generate a packaging provision plan which adopts one packaging material to package the selected multiple items, wherein the packaging display module displays the corresponding packaging material according to the packaging provision plan.

14. The gift giving system, as recited in claim 1, further comprising a gift list user interface which displays the gift list, wherein the gift list user interface further comprises a gift display area and a value conversion display area, wherein the gift display area presents information about a gift, while the value conversion display area is configured to display the value unit amount of the currently selected gift.

15. (canceled)

16. The gift giving system, as recited in claim 14, wherein the gift list user interface further comprises a digital gift display area for displaying received digital gifts.

17. The gift giving system, as recited in claim 13, wherein the gift list user interface further comprises a repackaging user interface for displaying operations to repackage multiple items, wherein the repackaging user interface further comprises at least one selected item display area and a repackaging display area, wherein the repackaging display area comprises at least one combined packaging display area for displaying at least one packaging material for packaging the at least one item selected in the selected item display area.

18. The gift giving system, as recited in claim 13, wherein the gift list user interface further provides a packaging demand submission area for submitting packaging requirements for the selected item.

19. A gift giving system, comprising:
a user module which manages a group of user accounts, wherein the user management module is configured to receive a gift list and stores the gift list in a corresponding user account of a recipient, wherein the gift list unit records at least one item and at least one packaging material corresponding to the item; and
a payment module, wherein the payment module converts the at least one packaging material in the gift list into at least one value unit mount of equal value corresponding to the packaging material, and stores the converted value unit amount in the user account corresponding to the recipient.

20. The gift giving system, as recited in claim 19, wherein the gift list further records an electronic gift, and the electronic gift is stored in the user module for a gift giver and the recipient to view.
